(19) United States
(12) Patent Application Publication
(10) Pub. No.: US 2009/0094695 A1
(43) Pub. Date: Apr. 9, 2009

(54) ACCOUNT ASSOCIATION GENERATION

(76) Inventors: Ravi Prakash Bansal, Tampa, FL (US); Saravanan Kannappan, Boynton Beach, FL (US); David George King, Oakville (CA); Robert A. Larsen, Hawthorn Woods, IL (US); Venkatesan Ramamorthy, Round Rock, TX (US); John Lee White, Wesley Chapel, FL (US)

Correspondence Address: IBM CORP (YA);C/O YEE & ASSOCIATES PC, P.O. BOX 802333, DALLAS, TX, 75380, US

(21) Appl. No.: 11/867,837

(22) Filed: Oct. 5, 2007

(51) Int. Cl. G06F 12/14

(52) U.S. Cl. 726/21

(57) ABSTRACT

Illustrative embodiments provide a computer implemented method, data processing system and computer program product for generating an association between a configuration item and an account. In one illustrative embodiment, the computer implemented method comprises selecting the configuration item requiring account association to create a selected configuration item, and selecting a set of rules for the selected configuration item to form a set of selected rules, wherein the selected set of rules is used to associate configuration items to accounts. Further the method determines whether a match is present between the set of selected rules and the selected configuration item, and responsive to determining that a match is present, obtains account mapping information for an account identified by the match, and associates the selected configuration item with the account using the account mapping information.

### BACKGROUND OF THE INVENTION

1. Field of the Invention

The present invention relates generally to an improved data processing system, and in particular to a computer implemented method, data processing system and computer program product for generating associations between configuration items and respective ownership in shared, multi-customer configuration management systems.

2. Description of the Related Art

With the growing interest in adopting best practices for systems management across information technology departments, organizations typically have implemented a variety of configuration management systems to help manage the inventory of information technology items. Some configuration management systems conform to a standard defined by a standards body, such as the Information Technology Infrastructure Library (ITIL).

Configuration management may be defined as the process of identifying, controlling, maintaining and verifying the specific items known as configuration items that comprise the information technology infrastructure supporting one or more business processes and services of a company. A configuration item may then be defined as an information technology asset, or a combination of information technology assets, that is managed by the configuration management system. Examples of configuration items include, but are not limited to, servers, network devices, hostnames, IP addresses, operating systems, and software applications, such as databases.

A key component of a configuration management system is a configuration management database. A configuration management database is a repository that maintains data related to the logical configurations of elements that comprise the information technology infrastructure of a business. A configuration management database is typically implemented as a relational database system with data elements that store data for different configuration item instances and their relationships with other configuration item instances.

Additionally, a configuration management system may use discovery services to populate the configuration management database. Discovery services, also known as an inventory scan, may populate an inventory database either by agent-based or agent-less mechanisms and sensors to connect to the configuration items in the environment and identify the hardware and software details of the configuration items and the relationships between them. The data gathered by discovery services enables the creation and visualization of the topology of an information technology environment.

Information technology service providers that provide hosting and data center services for customers normally use a “shared” configuration management system wherein data for configuration items associated with multiple customers may be stored. In order to segregate configuration item data for specific customers, the data is associated with accounts through configuration item and account relationships. These relationships are important to implement access control, reporting, and management of configuration items differentiated by customer accounts.

Typically, configuration management systems employing discovery services can only gather data sensed programmerically from a configuration item. For example, for a configuration item such as a server, a discovery service can only gather hardware information including processor type, processor speed, memory size, and disk size. A discovery service may also gather software information, including installed operating systems and software applications.

However, an important piece of information that a discovery service cannot typically gather is the customer account to which a configuration item is associated. This information usually has to be entered manually through a graphical user interface (GUI) usually provided with the discovery service. To enter this information, system administrators and operators of the configuration management system have to transpose information from reference spreadsheets and other records that have this information to the configuration management database.

For a configuration management system that manages thousands of configuration items and hundreds of customers, creating associations between the configuration items and customer accounts can become a time consuming and costly manual process. In addition, manually associating configuration items with customer accounts is often error-prone.

### SUMMARY OF THE INVENTION

Illustrative embodiments provide a computer implemented method, data processing system and computer program product for generating an association between a configuration item and an account.

The computer implemented method comprising, selecting the configuration item requiring account association to create a selected configuration item, selecting a set of rules for the selected configuration item to form a set of selected rules, wherein the selected set of rules is used to associate configuration items to accounts, determining whether a match is present between the set of selected rules and the selected configuration item, responsive to determining that a match is present, obtaining account mapping information for an account identified by the match, and associating the selected configuration item with the account using the account mapping information.

The data processing system comprising: a bus; a storage device connected to the bus, wherein the storage device contains computer usable code; at least one managed device connected to the bus; a communications unit connected to the bus; and a processing unit, connected to the bus, wherein the processing unit executes the computer usable code to select the configuration item requiring account association to create a selected configuration item, select a set of rules for the selected configuration item to form a set of selected rules, wherein the selected set of rules is used to associate configuration items to accounts, determine whether a match is present between the set of selected rules and the selected configuration item, responsive to determining that a match is present, obtain account mapping information for an account identified by the match; and associate the selected configuration item with the account using the account mapping information,

The computer program product comprising a computer usable recordable-type medium having computer usable program code tangibly embodied thereon, the computer usable program code comprising, computer usable program code for selecting the configuration item requiring account association to create a selected configuration item, computer usable program code for selecting a set of rules for the selected configuration item to form a set of selected rules, wherein the selected set of rules is used to associate configuration items to accounts, computer usable program code for determining whether a match is present between the set of selected rules and the selected configuration item, computer usable program code responsive to determining that a match is present, for obtaining account mapping information for an account identified by the match, and computer usable program code for associating the selected configuration item with the account using the account mapping information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system of FIG. 1 in which illustrative embodiments may be implemented;

FIG. 3 is a block diagram of a configuration management system in accordance with illustrative embodiments;

FIG. 4 is a tabular view of a configuration management table in accordance with illustrative embodiments;

FIG. 5 is a tabular view of a account mapping table in accordance with illustrative embodiments; and

FIG. 6 is a flowchart of a process for associating accounts with configuration items in accordance with an illustrative embodiment.

### DETAILED DESCRIPTION OF THE PREFERRED EMBODIMENT

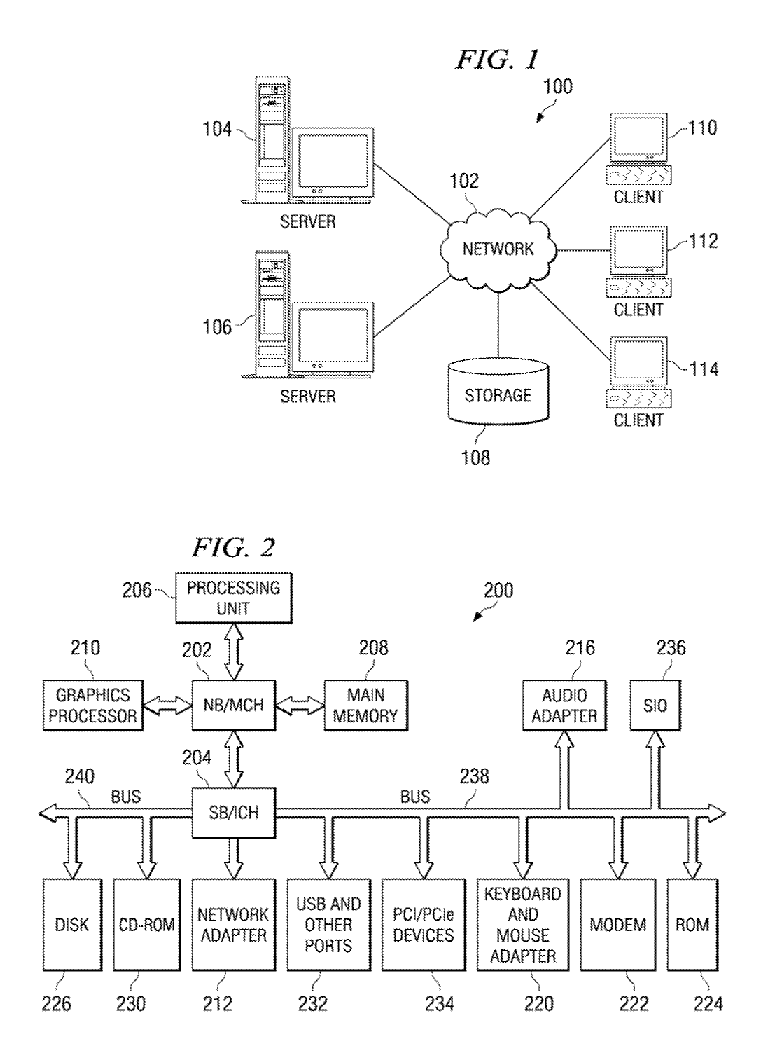

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown, tie this drawing to the invention—give a sentence or two about the use of configuration mgmt systems and information.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICR) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers, PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit. 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Account association in accordance with illustrative embodiments provides an ownership association beyond that which can be readily attained by asset discovery. Scanning discovered assets that have no account information creates a set of selected configuration items for processing. Programmatic matching between a set of selected rules and a selected configuration item is performed and when a match is present account mapping information for an account identified by the match is obtained. The selected configuration item is then associated with the account using the account mapping information. Ownership is now established for the configuration to supplement other attributes that, may have been obtained during a resource discovery process,

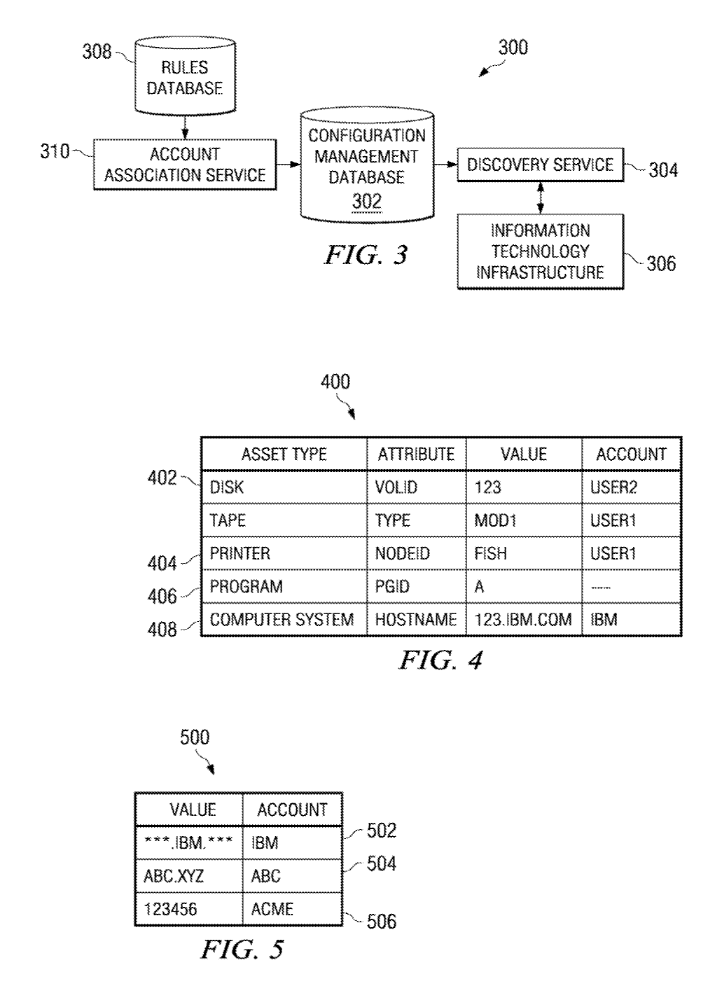

Turning to FIG. 3, there is depicted a block diagram of a configuration management system incorporating an account association service in accordance with illustrative embodiments. Configuration management system 300 comprises configuration management database 302 containing data elements that store data for different configuration item instances and their relationships with other configuration item instances. Configuration management database 302 contains data for a “shared” configuration management system where data for configuration items associated with multiple customers may be stored. In order to segregate configuration item data for specific customers, the data is associated with accounts through configuration item and account relationships.

Configuration management system 300 also includes discovery service 304 that gathers data sensed programmatically from a configuration item contained within information technology infrastructure 306. In addition, configuration management system 300 also includes a repository in the form of rules database 308 containing a plurality of association rules developed to work in cooperation with account association service 310 that is accessible to configuration management database 302 of the configuration management system.

Rules database 308 typically stores rule conditions and corresponding rule-account associations. A rule is comprised of a condition portion and an association portion. The rule condition portion typically consists of a configuration item type, the name of an attribute belonging to that type and an attribute value comprised of a pattern to be matched. The rule-account association portion consists of the name of an account a specific configuration item would be associated with if the configuration item matches the condition of the respective rule. A rule may use more than one attribute with an associated pattern to further qualify configuration items of interest.

For example, a rule may typically be stated as the combination of a condition portion “if configuration item type is a ‘computer system’ and if the value of a hostname attribute matches the pattern ‘*ibm.com’”, and an association portion “then the account is IBM”. During the account association processing, if a configuration item of the type “computer system” with a hostname attribute having the value “123.ibm.com” is found, and if the aforementioned rule exists in rules database 308, then account association service 310 would determine this instance of “computer system” to be associated with a customer account “IBM”.

It may be noted that rules for other configuration item types such as, but not limited to, routers and printers can be defined in a similar fashion. In addition, a plurality of rules can be defined for a single type of configuration item, each rule involving a different attribute or a combination of attributes. Thus, rules created may be as specific or as general as required by the configuration item attributes collected.

If a plurality of rules is defined for a single configuration item type, then a rank, may be assigned to each of the rules so that rule matching can be performed in the order of the rankings until a match is obtained or not obtained. The combination of rules database 308 and account association service 310 forms a useful inference rule-based system using pattern matching of configuration item attribute values with target account information to perform a proper configuration item account relation.

With reference to FIG. 4 a tabular view of a configuration management table in accordance with illustrative embodiments is depicted. For example, configuration management database 302 of FIG. 3 may have entries including but not limited, to those shown in table 400. Table 400 is represented by a combination of rows and columns in which is depicted various combinations of asset type, attribute, value and account information. For example, row 402 contains an entry for and asset type of disk, row 404 has an entry for printer, row 406 has an entry for Program and row 408 has an entry for computer system. Row 408 further has entries for an attribute of hostname, a value of “123.ibm.com” and an account of “IBM”. Row 406 having an entry for Program has an attribute of PGID, a value of “A” but does not have account information provided. Scanning configuration database 302 of FIG. 3 for entries without an account association would produce an entry for row 406.

With reference to FIG. 5 a tabular view of an account mapping table in accordance with illustrative embodiments is depicted. Table 500 may be representative of a simple association of attribute values with accounts. For example, row 502 has a value of “***.ibm. ***” representing a combination of three qualifiers and an account of “IBM.” In this example an asset type with any attribute value having “ibm” as the middle component will have the “IBM” account assigned. In a similar manner row 504 depicts a value of “ABC.XYZ” and a corresponding account of “ABC”, while row 506 has an attribute value of “123456”, which may indicate a device volume serial number, and a corresponding account of “ACME”.

The tables represented in FIG. 4 and FIG. 5 are exemplary and not exhaustive nor indicative of a prescribed implementation.

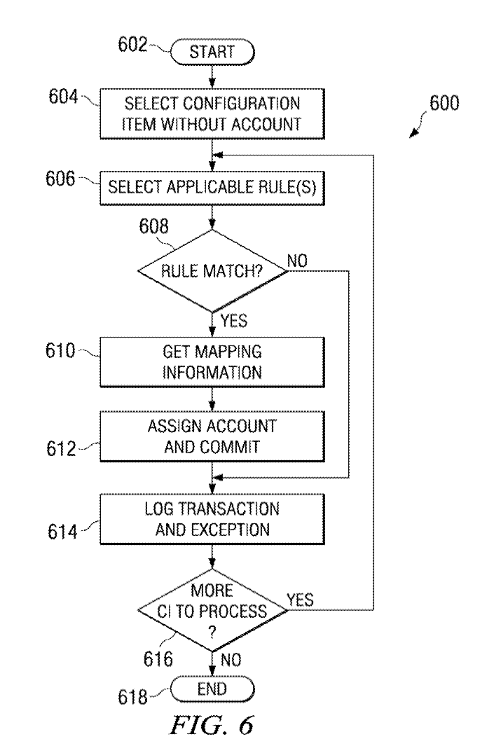

Referring now to FIG. 6, a flowchart of a process for associating accounts with configuration items in accordance with illustrative embodiments is depicted. The process scans a configuration database for configuration items that do not have an account association. A set of rules is then used in a matching process between the configuration items needing an account association and account information. The matching process typically applies selection logic and pattern matching to make a match determination. For example, a configuration item of “computer system” discovered during the scan may have a hostname attribute of “123.ibm.com.” A rule may exist in the rules database for hostnames having a pattern of an exact value or may include wildcards. When applied, the rule of this example, would assign an account of “ibm” to the “computer system” based on the finding of “123.ibm.com” as a hostname. The account mapping information is typically provided in mapping table. For example, the table may comprise a set of rows in which one row there is an entry for a hostname, such as “123.ibm.com” or portion thereof, and a corresponding entry for an account assignment of “IBM”. In these examples account association process 600 may be implemented in a software component, such as account association service 310 in FIG. 3.

Account association process 600 begins in step 602. Configuration management database 302 in FIG. 3 is scanned for orphan configuration items to select configuration items without account associations (step 604). Configuration items having account associations are skipped as they need no further processing. Having obtained a configuration item needing an account association, an applicable rule is selected based on the type of the configuration item (step 606), for example, if the configuration item represented a computer system, the rule for computer system would be selected from the rules database. In case a plurality of rules are defined for a configuration item type, then the whole set of such rules is selected.

If a single rule was selected, then its condition is compared against the attribute values of the configuration item obtained to determine a match (step 608). If a plurality of rules was selected, then the rules are similarly processed individually in the order of ranking to determine a match. For example if there were rules including a device type and a hostname, the rule having hostname may be higher ranked as being more specific. Using the example, if one rule stated “disk” and a value of “123” representing perhaps a device address or type and another rule stated “hostname” and a value of “company A”, then one may consider using the more specific “hostname” mapping to more clearly perform the account information association. An asset type of disk maybe shared or not, and is therefore not as asset specific as hostname. If a match is attained (“yes” in step 608), then the account mapping information is retrieved by the account association service from the matched rule's association in the rules database (step 610). With the proper association having been determined, the information is then passed from account association service and recorded in configuration management database (step 612). The successful transaction is then logged, or if there was an error during the processing and an exception created, that too would be logged (step 614). A determination is then made if there are more configuration items to process (step 616). If a “yes” occurs in the determination made in step 616, processing reverts to step 606; otherwise, if “no” in step 616, process 600 would end (step 618).

Returning now to step 608, if the determination result was “no”, then process 600 would skip to step 614, wherein an exception is logged with the configuration item being processed. The exception may require a rule change within or a rule addition to be made to the rules database that would typically be processed by an authorized administrator.

Illustrative embodiments provide for associating account information to a configuration item which previously had no account information associated. In accordance with illustrative embodiments matching between a set of selected rules and a selected configuration item is performed and when a match is present account mapping information for an account identified by the match is obtained. The selected configuration item is then associated with the account using the account mapping information. In this manner account information may be programmatically assigned to configuration items using the capability of rules and pattern matching to more effectively add the necessary information to configuration items than would be possible if done manually.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable type medium include a semiconductor or solid state memory, magnetic tape, a removable computer diskette, a random access memory (RAH), a read-only memory (ROM), a rigid magnetic disk and an optical disk. Current examples of optical disks include compact disk—read only memory (CD-ROM), compact disk—read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a transmission type medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just, a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating an association between a configuration item and an account, the computer implemented method comprising;
selecting the configuration item requiring account association to create a selected configuration item;
selecting a set of rules for the selected configuration item to form a set of selected rules, wherein the selected set of rules is used to associate configuration items to accounts;
determining whether a match is present between the set of selected rules and the selected configuration item;
responsive to determining that a match is present, obtaining account mapping information for an account identified by the match; and
associating the selected configuration item with the account using the account mapping information.

2. The computer implemented method of claim 1, wherein selecting the configuration item further comprises scanning a configuration management database for the configuration item without account information.

3. The computer implemented method of claim 1, wherein selecting the set of rules further comprises matching a type of the configuration item.

4. The computer implemented method of claim 1, wherein determining the match is present further comprises selecting a single rule whose pattern matches an attribute value of the configuration item.

5. The computer implemented method of claim 1, wherein obtaining account mapping information further comprises obtaining the account mapping information from an account association service.

6. The computer implemented method of claim 1, wherein associating the selected configuration item further comprises recording the account information into a configuration management database.

7. The computer implemented method of claim 1 further comprising logging by recording of transactions processed and exceptions created.

8. A data processing system for generating an association between a configuration item and an account, the data processing system comprising;
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to:
select the configuration item requiring account association to create a selected configuration item;
select a set of roles for the selected configuration item to form a set of selected rules, wherein the selected set of rules is used to associate configuration items to accounts;
determine whether a match is present between the set of selected rules and the selected configuration item; and
responsive to determining that a match is present, obtain account mapping information for an account identified by the match; and
associate the selected configuration item with the account using the account mapping information.

9. The data processing system of claim 8, wherein select the configuration item further comprises scanning a configuration management database for the configuration item without account information.

10. The data processing system of claim 8, wherein select the set of rules further comprises selecting rules corresponding to a type of the configuration item and matching at least one rule.

11. The data processing system of claim 8, wherein obtain account mapping information further comprises obtaining the account mapping information from an account association service.

12. The data processing system of claim 8, wherein associate the selected configuration item further comprises recording the account information into a configuration management database.

13. The data processing system of claim 8 further comprising logging by recording of processed transactions and exceptions created.

14. A computer program product for generating an association between a configuration item and an account, the computer program product comprising:
a computer usable recordable-type medium having computer usable program code tangibly embodied thereon, the computer usable program code comprising:
computer usable program code for selecting the configuration item requiring account association to create a selected configuration item;
computer usable program code for selecting a set of rules for the selected configuration item to form a set of selected rules, wherein the selected set of rules is used to associate configuration items to accounts;
computer usable program code for determining whether a match is present between the set of selected rules and the selected configuration item;
computer usable program code responsive to determining that, a match is present, for obtaining account mapping information for an account identified by the match; and
computer usable program code for associating the selected configuration item with the account using the account mapping information.

15. The computer program product of claim 14, wherein the computer usable program code for selecting the configuration item further comprises computer usable program code for scanning a configuration management database for the configuration item without account information.

16. The computer program product of claim 14, wherein the computer usable program code for selecting the set of rules further comprises computer usable program code for selecting rules corresponding to a type of the configuration item and matching at least one rule.

17. The computer program product of claim 14, wherein the computer usable program code for obtaining account mapping information further comprises computer usable program code for obtaining the account mapping information from an account association service.

18. The computer program product of claim 14, wherein the computer usable program code for associating the selected configuration item further comprises computer usable program code for recording the account information into a configuration management database.

19. The computer program product of claim 14 further comprising computer usable program code for logging by recording of processed transactions and exceptions created.
